(19) United States
(12) Patent Application Publication
(10) Pub. No.: US 2011/0137966 A1
(43) Pub. Date: Jun. 9, 2011

(54) METHODS AND SYSTEMS FOR PROVIDING A UNIFIED NAMESPACE FOR MULTIPLE NETWORK PROTOCOLS

(75) Inventors: Sudhir Srinivasan, Acton, MA (US); Garth Goodson, Fremont, CA (US); Zi-Bin Yang, San Francisco, CA (US)

(73) Assignee: NetApp, Inc., Sunnyvale, CA (US)

(21) Appl. No.: 12/698,019

(22) Filed: Feb. 1, 2010

Related U.S. Application Data
(60) Provisional application No. 61/267,770, filed on Dec. 8, 2009.

(51) Int. Cl. G06F 17/30

(52) U.S. Cl. 707/828; 707/E17.01

(57) ABSTRACT

A network storage server system includes a presentation layer that presents multiple namespaces over the same data stored in an object store, allowing users to simultaneously access data over multiple protocols. The system supports object location independence of the stored data objects by introducing a layer of indirection between directory entries and storage locations of stored data objects. In one embodiment, the directory entry of a data object points to a redirector file that includes an object locator (e.g., an object handle or a global object ID) of the data object. The directory entries of data objects are stored in a directory namespace (e.g., NAS path namespace). In another embodiment, a global object ID of the data object is directly encoded within the directory entry of the data object.

### CLAIM OF PRIORITY

This application claims priority to U.S. Provisional Application No. 61/267,770, entitled, “Methods and Systems for Providing a Unified Namespace for Multiple Network Protocols,” filed Dec. 8, 2009, which is incorporated herein by reference.

### FIELD OF THE INVENTION

At least one embodiment of the present invention pertains to network storage systems, and more particularly, to methods and systems for providing a unified namespace to access data objects in a network storage system using multiple network protocols.

### BACKGROUND

Network based storage, or simply “network storage”, is a common approach to backing up data, making large amounts of data accessible to multiple users, and other purposes. In a network storage environment, a storage server makes data available to client (host) systems by presenting or exporting to the clients one or more logical containers of data. There are various forms of network storage, including network attached storage (NAS) and storage area network (SAN). In a NAS context, a storage server services file-level requests from clients, whereas in a SAN context a storage server services block-level requests. Some storage servers are capable of servicing both file-level requests and block-level requests.

There are several trends that are relevant to network storage technology. The first is that the amount of data being stored within a typical enterprise is approximately doubling from year to year. Second, there are now multiple mechanisms (or protocols) by which a user may wish to access data stored in network storage system. For example, consider a case where a user wishes to access a document stored at a particular location in a network storage system. The user may use an NFS protocol to access the document over a local area network in a manner similar to how local storage, is accessed. The user may also use an HTTP protocol to access a document over a wide area network such as an Internet network. Traditional storage systems use a different storage mechanism (e.g., a different file system) for presenting data over each such protocol. Accordingly, traditional network storage systems do not allow the same stored data to be accessed concurrently over multiple different protocols at the same level of a protocol stack.

In addition, network storage systems presently are constrained in the way they allow a user to store or navigate data. Consider, for example, a photo that is stored under a given path name, such as “/home/eng/myname/office.jpeg”. In a traditional network storage system, this path name maps to a specific volume and a specific file location (e.g., inode number). Thus, a path name of a file (e.g., a photo) is closely tied to the file's storage location. In other words, the physical storage location of the file is determined by the path name of the file. Accordingly, in traditional storage systems, the path name of the file needs to be updated every time the physical storage location of the file changes (e.g., when the file is transferred to a different storage volume). This characteristic significantly limits the flexibility of the system.

### SUMMARY

Introduced here and described below in detail is a network storage server system that implements a presentation layer that presents stored data concurrently over multiple network protocols. The presentation layer operates logically on top of an object store. The presentation layer provides multiple interfaces for accessing data stored in the object store, including a NAS interface and a Web Service interface. The presentation layer further provides at least one namespace for accessing data via the NAS interface or the Web Service interface. The NAS interface allows access to data stored in the object store via the namespace. The Web Service interface allows access to data stored in the object store either via the namespace (“named object access”) or without using the namespace (“raw object access” or “flat object access”). The presentation layer also introduces a layer of indirection between (i.e., provides a logical separation of) the directory entries of stored data objects and the storage locations of such data objects, which facilitates transparent migration of data objects and enables any particular data object to be represented by multiple paths names, thereby facilitating navigation.

The system further supports location independence of data objects stored in the distributed object store. This allows the physical locations of data objects within the storage system to be transparent to users and clients. In one embodiment, the directory entry of a given data object points to a redirector file instead of pointing to a specific storage location (e.g., an inode) of the given data object. The redirector file includes an object locator (e.g., an object handle or a global object ID) of the given data object. In one embodiment, the directory entries of data objects and the redirector files are stored in a directory namespace (such as the NAS path namespace). The directory namespace is maintained by the presentation layer of the network storage server system. In this embodiment, since the directory entry of a data object includes a specific location (e.g., inode number) of the redirector file and not the specific location of the data object, the directory entry does not change value even if the data object is relocated within the distributed object store.

In one embodiment, a global object ID of the data object is directly encoded within the directory entry of the data object. In such an embodiment, the directory entry does not point to a redirector file, instead it directly contains the global object ID. The global object ID does not change with a change in location of the data object (within the distributed object store). Therefore, even in this embodiment, the directory entry of the data object does not change value even if the data object is relocated within the distributed object store.

Accordingly, the network storage server system introduces a layer of indirection between (i.e., provides a logical separation of) directory entries and storage locations of the stored data object. This separation facilitates transparent migration (i.e., a data object can be moved without affecting its name), and moreover, it enables any particular data object to be represented by multiple path names, thereby facilitating navigation. In particular, this allows the implementation of a hierarchical protocol such as NFS on top of an object store, while at the same time maintaining the ability to do transparent migration.

Other aspects of the technique will be apparent from the accompanying figures and from the detailed description which follows.

### BRIEF DESCRIPTION OF THE DRAWINGS

One or more embodiments of the present invention are illustrated by way of example and not limitation in the figures of the accompanying drawings, in which like references indicate similar elements.

FIG. 1 illustrates a network storage environment in which the present invention can be implemented.

FIG. 2 illustrates a clustered network storage environment in which the present invention can be implemented.

FIG. 3 is a high-level block diagram showing an example of the hardware architecture of a storage controller that can implement one or more storage server nodes.

FIG. 4 illustrates an example of a storage operating system of a storage server node.

FIG. 5 illustrates the overall architecture of a content repository according to one embodiment.

FIG. 6 illustrates how a content repository can be implemented in the clustered architecture of FIGS. 2 through 4.

FIG. 7 illustrates a multilevel object handle.

FIG. 8 illustrates a mechanism that allows the server system to introduce a layer of separation between a directory entry of a data object and the physical location where the data object is stored.

FIG. 9 illustrates a mechanism that allows the server system to introduce a layer of separation between the directory entry of the data object and the physical location of the data object by including a global object ID within the directory entry.

FIG. 10 is a first example of a process by which the server system stores a data object received from a storage client, while keeping the directory entry of the data object transparent from the storage location of the data object.

FIG. 11 is a second example of a process by which the server system stores a data object received from a storage client, while keeping the directory entry of the data object transparent from the storage location of the data object.

FIG. 12 is a flow diagram showing an example of a process by which the server system responds to a lookup request made by a storage client.

FIG. 13 is an exemplary architecture of a server system configured to transmit an object locator to a client in response to a request from the client.

### DETAILED DESCRIPTION

References in this specification to “an embodiment”, “one embodiment”, or the like, mean that the particular feature, structure or characteristic being described is included in at least one embodiment of the present invention. Occurrences of such phrases in this specification do not necessarily all refer to the same embodiment.

### System Environment

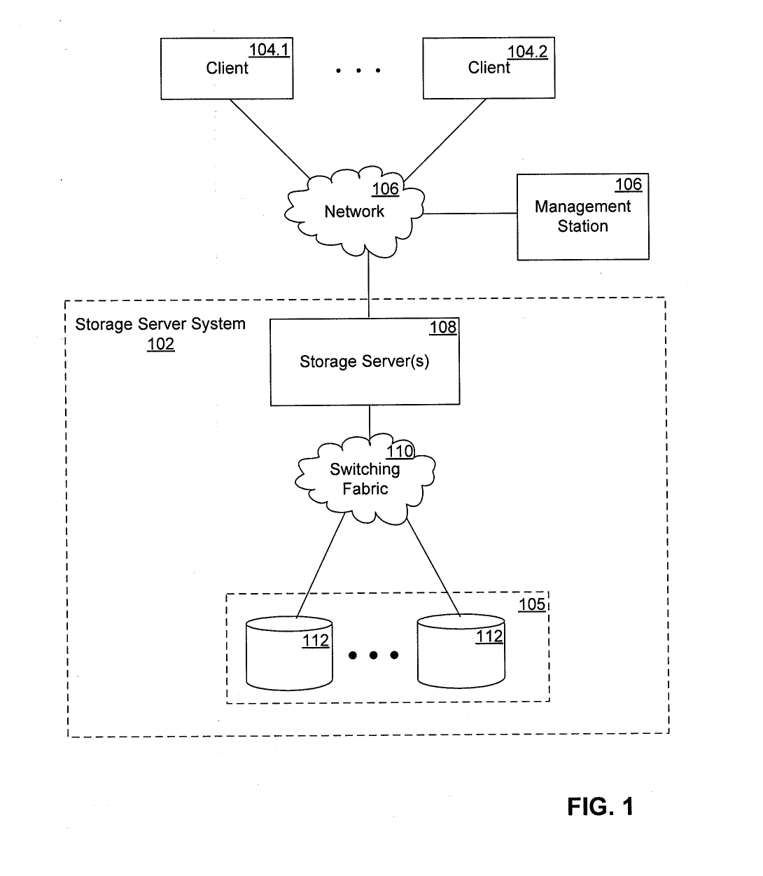

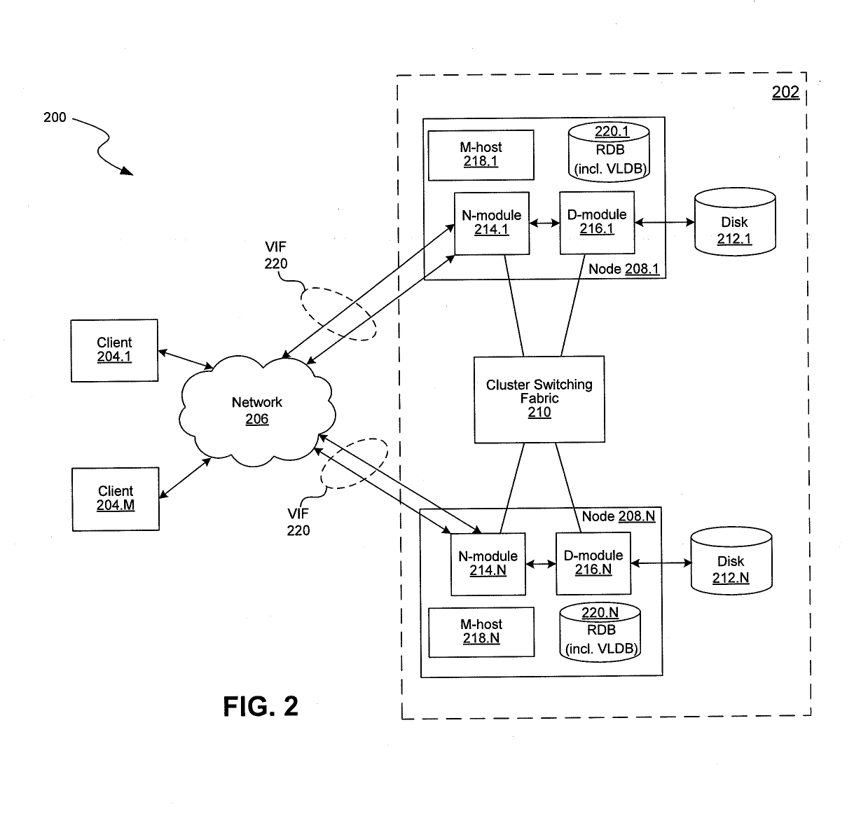

FIGS. 1 and 2 show, at different levels of detail, a network configuration in which the techniques introduced here can be implemented. In particular, FIG. 1 shows a network data storage environment, which includes a plurality of client systems 104.1-104.2, a storage server system 102, and computer network 106 connecting the client systems 104.1-104.2 and the storage server system 102. As shown in FIG. 1, the storage server system 102 includes at least one storage server 108, a switching fabric 110, and a number of mass storage devices 112, such as disks, in a mass storage subsystem 105. Alternatively, some or all of the mass storage devices 212 can be other types of storage, such as flash memory, solid-state drives (SSDs), tape storage, etc.

The storage server (or servers) 108 may be, for example, one of the FAS-xxx family of storage server products available from NetApp, Inc. The client systems 104.1-104.2 are connected to the storage server 108 via the computer network 106, which can be a packet-switched network, for example, a local area network (LAN) or wide area network (WAN). Further, the storage server 108 is connected to the disks 112 via a switching fabric 110, which can be a fiber distributed data interface (FDDI) network, for example. It is noted that, within the network data storage environment, any other suitable numbers of storage servers and/or mass storage devices, and/or any other suitable network technologies, may be employed. While FIG. 1 implies, in some embodiments, a fully connected switching fabric 110 where storage servers can see all storage devices, it is understood that such a connected topology is not required. In some embodiments, the storage devices can be directly connected to the storage servers such that no two storage servers see a given storage device.

The storage server 108 can make some or all of the storage space on the disk(s) 112 available to the client systems 104.1-104.2 in a conventional manner. For example, each of the disks 112 can be implemented as an individual disk, multiple disks (e.g., a RAID group) or any other suitable mass storage device(s). The storage server 108 can communicate with the client systems 104.1-104.2 according to well-known protocols, such as the Network File System (NFS) protocol or the Common Internet File System (CIFS) protocol, to make data stored on the disks 112 available to users and/or application programs. The storage server 108 can present or export data stored on the disk 112 as volumes to each of the client systems 104.1-104.2. A “volume” is an abstraction of physical storage, combining one or more physical mass storage devices (e.g., disks) or parts thereof into a single logical storage object (the volume), and which is managed as a single administrative unit, such as a single file system. A “file system” is a structured (e.g., hierarchical) set of stored logical containers of data (e.g., volumes, logical unit numbers (LUNs), directories, files). Note that a “file system” does not have to include or be based on “files” per se as its units of data storage.

Various functions and configuration settings of the storage server 108 and the mass storage subsystem 105 can be controlled from a management station 106 coupled to the network 106. Among many other operations, a data object migration operation can be initiated from the management station 106.

FIG. 2 depicts a network data storage environment, which can represent a more detailed view of the environment in FIG. 1. The environment 200 includes a plurality of client systems 204 (204.1-204.M), a clustered storage server system 202, and a computer network 206 connecting the client systems 204 and the clustered storage server system 202. As shown in FIG. 2, the clustered storage server system 202 includes a plurality of server nodes 208 (208.1-208.N), a cluster switching fabric 210, and a plurality of mass storage devices 212 (212.1-212.N), which can be disks, as henceforth assumed here to facilitate description. Alternatively, some or all of the mass storage devices 212 can be other types of storage, such as flash memory, SSDs, tape storage, etc. Note that more than one mass storage device 212 can be associated with each node 208.

Each of the nodes 208 is configured to include several modules, including an N-module 214, a D-module 216, and an M-host 218 (each of which can be implemented by using a separate software module) and an instance of a replicated database (RDB) 220. Specifically, node 208.1 includes an N-module 214.1, a D-module 216.1, and an M-host 218.1; node 208.N includes an N-module 214.N, a D-module 216.N, and an M-host 218.N; and so forth. The N-modules 214.1-214.M include functionality that enables nodes 208.1-208.N, respectively, to connect to one or more of the client systems 204 over the network 206, while the D-modules 216.1-216.N provide access to the data stored on the disks 212.1-212.N, respectively. The M-hosts 218 provide management functions for the clustered storage server system 202. Accordingly, each of the server nodes 208 in the clustered storage server arrangement provides the functionality of a storage server.

The RDB 220 is a database that is replicated throughout the cluster, i.e., each node 208 includes an instance of the RDB 220. The various instances of the RDB 220 are updated regularly to bring them into synchronization with each other. The RDB 220 provides cluster-wide storage of various information used by all of the nodes 208, including a volume location database (VLDB) (not shown). The VLDB is a database that indicates the location within the cluster of each volume in the cluster (i.e., the owning D-module 216 for each volume) and is used by the N-modules 214 to identify the appropriate D-module 216 for any given volume to which access is requested.

The nodes 208 are interconnected by a cluster switching fabric 210, which can be embodied as a Gigabit Ethernet switch, for example. The N-modules 214 and D-modules 216 cooperate to provide a highly-scalable, distributed storage system architecture of a clustered computing environment implementing exemplary embodiments of the present invention. Note that while there is shown an equal number of N-modules and D-modules in FIG. 2, there may be differing numbers of N-modules and/or D-modules in accordance with various embodiments of the technique described here. For example, there need not be a one-to-one correspondence between the N-modules and D-modules. As such, the description of a node 208 comprising one N-module and one D-module should be understood to be illustrative only.

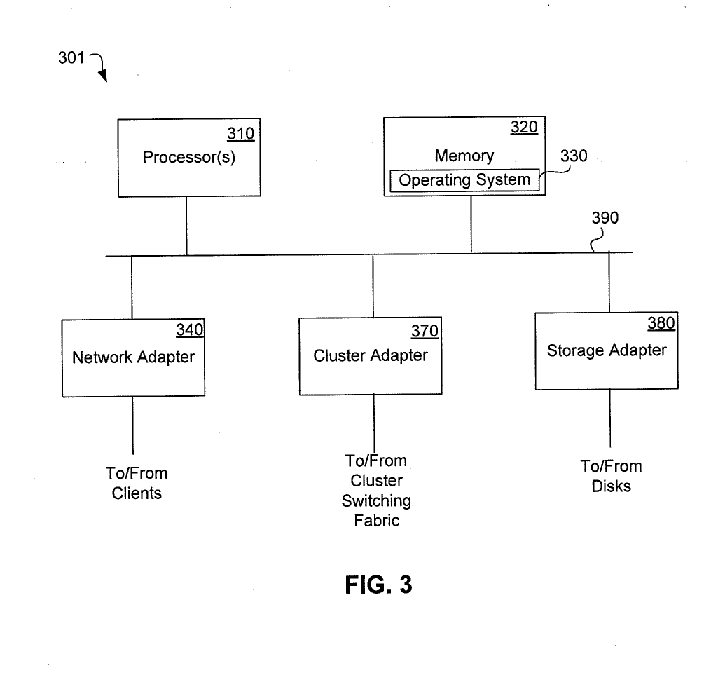

FIG. 3 is a diagram illustrating an example of a storage controller that can implement one or more of the storage server nodes 208. In an exemplary embodiment, the storage controller 301 includes a processor subsystem that includes one or more processors. The storage controller 301 further includes a memory 320, a network adapter 340, a cluster access adapter 370 and a storage adapter 380, all interconnected by an interconnect 390. The cluster access adapter 370 includes a plurality of ports adapted to couple the node 208 to other nodes 208 of the cluster. In the illustrated embodiment, Ethernet is used as the clustering protocol and interconnect media, although other types of protocols and interconnects may be utilized within the cluster architecture described herein. In alternative embodiments where the N-modules and D-modules are implemented on separate storage systems or computers, the cluster access adapter 270 is utilized by the N-module 214 and/or D-module 216 for communicating with other N-modules and/or D-modules of the cluster.

The storage controller 301 can be embodied as a single- or multi-processor storage system executing a storage operating system 330 that preferably implements a high-level module, such as a storage manager, to logically organize the information as a hierarchical structure of named directories, files and special types of files called virtual disks (hereinafter generally “blocks”) on the disks. Illustratively, one processor 310 can execute the functions of the N-module 214 on the node 208 while another processor 310 executes the functions of the D-module 216.

The memory 320 illustratively comprises storage locations that are addressable by the processors and adapters 340, 370, 380 for storing software program code and data structures associated with the present invention. The processor 310 and adapters may, in turn, comprise processing elements and/or logic circuitry configured to execute the software code and manipulate the data structures. The storage operating system 330, portions of which is typically resident in memory and executed by the processors(s) 310, functionally organizes the storage controller 301 by (among other things) configuring the processor(s) 310 to invoke storage operations in support of the storage service provided by the node 208. It will be apparent to those skilled in the art that other processing and memory implementations, including various computer readable storage media, may be used for storing and executing program instructions pertaining to the technique introduced here.

The network adapter 340 includes a plurality of ports to couple the storage controller 301 to one or more clients 204 over point-to-point links, wide area networks, virtual private networks implemented over a public network (Internet) or a shared local area network. The network adapter 340 thus can include the mechanical, electrical and signaling circuitry needed to connect the storage controller 301 to the network 206. Illustratively, the network 206 can be embodied as an Ethernet network or a Fibre Channel (FC) network. Each client 204 can communicate with the node 208 over the network 206 by exchanging discrete frames or packets of data according to pre-defined protocols, such as TCP/IP.

The storage adapter 380 cooperates with the storage operating system 330 to access information requested by the clients 204. The information may be stored on any type of attached array of writable storage media, such as magnetic disk or tape, optical disk (e.g., CD-ROM or DVD), flash memory, solid-state disk (SSD), electronic random access memory (RAM), micro-electro mechanical and/or any other similar media adapted to store information, including data and parity information. However, as illustratively described herein, the information is stored on disks 212. The storage adapter 380 includes a plurality of ports having input/output (I/O) interface circuitry that couples to the disks over an I/O interconnect arrangement, such as a conventional high-performance, Fibre Channel (FC) link topology.

Storage of information on disks 212 can be implemented as one or more storage volumes that include a collection of physical storage disks cooperating to define an overall logical arrangement of volume block number (VBN) space on the volume(s). The disks 212 can be organized as a RAID group. One or more RAID groups together form an aggregate. An aggregate can contain one or more volumes/file systems.

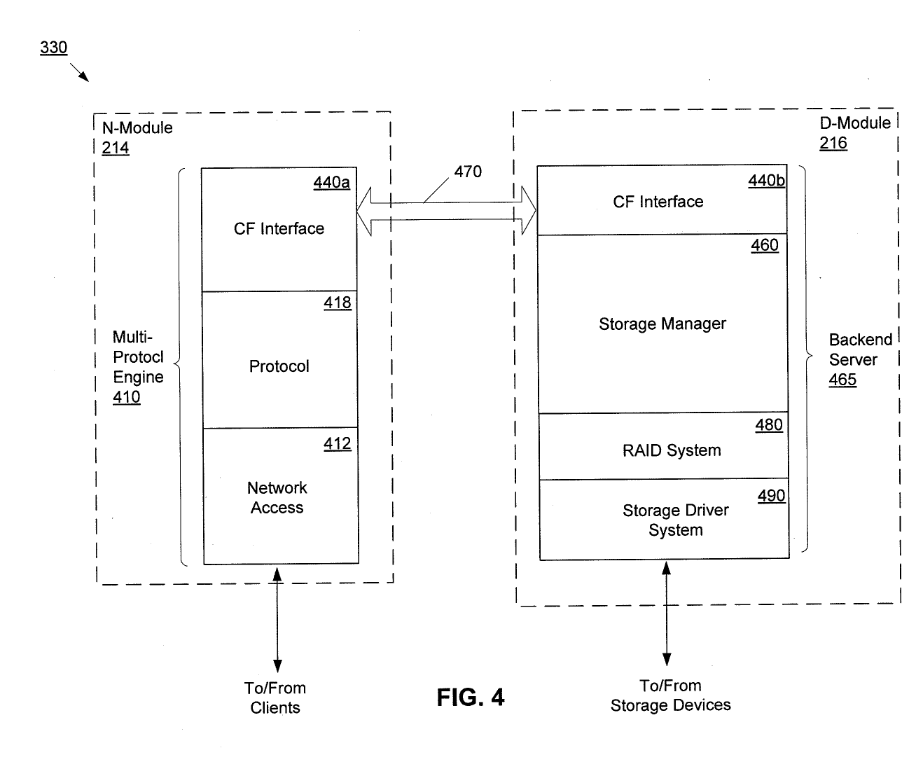

The storage operating system 330 facilitates clients' access to data stored on the disks 212. In certain embodiments, the storage operating system 330 implements a write-anywhere file system that cooperates with one or more virtualization modules to “virtualize” the storage space provided by disks 212. In certain embodiments, a storage manager 460 (FIG. 4) logically organizes the information as a hierarchical structure of named directories and files on the disks 212. Each “on-disk” file may be implemented as set of disk blocks configured to store information, such as data, whereas the directory may be implemented as a specially formatted file in which names and links to other files and directories are stored. The virtualization module(s) allow the storage manager 460 to further logically organize information as a hierarchical structure of blocks on the disks that are exported as named logical unit numbers (LUNs).

In the illustrative embodiment, the storage operating system 330 is a version of the Data ONTAP® operating system available from NetApp, Inc. and the storage manager 460 implements the Write Anywhere File Layout (WAFL®) file system. However, other storage operating systems are capable of being enhanced or created for use in accordance with the principles described herein.

FIG. 4 is a diagram illustrating an example of storage operating system 330 that can be used with the technique introduced here. In the illustrated embodiment the storage operating system 330 includes multiple functional layers organized to form an integrated network protocol stack or, more generally, a multi-protocol engine 410 that provides data paths for clients to access information stored on the node using block and file access protocols. The multiprotocol engine 410 in combination with underlying processing hardware also forms the N-module 214. The multi-protocol engine 410 includes a network access layer 412 which includes one or more network drivers that implement one or more lower-level protocols to enable the processing system to communicate over the network 206, such as Ethernet, Internet Protocol (IP), Transport Control Protocol/Internet Protocol (TCP/IP), Fibre Channel Protocol (FCP) and/or User Datagram Protocol/Internet Protocol (UDP/IP). The multiprotocol engine 410 also includes a protocol layer which implements various higher-level network protocols, such as Network File System (NFS), Common Internet File System (CIFS), Hypertext Transfer Protocol (HTTP), Internet small computer system interface (iSCSI), etc. Further, the multiprotocol engine 410 includes a cluster fabric (CF) interface module 440a which implements intra-cluster communication with D-modules and with other N-modules.

In addition, the storage operating system 330 includes a set of layers organized to form a backend server 465 that provides data paths for accessing information stored on the disks 212 of the node 208. The backend server 465 in combination with underlying processing hardware also forms the D-module 216. To that end, the backend server 465 includes a storage manager module 460 that manages any number of volumes 472, a RAID system module 480 and a storage driver system module 490.

The storage manager 460 primarily manages a file system (or multiple file systems) and serves client-initiated read and write requests. The RAID system 480 manages the storage and retrieval of information to and from the volumes/disks in accordance with a RAID redundancy protocol, such as RAID-4, RAID-5, or RAID-DP, while the disk driver system 490 implements a disk access protocol such as SCSI protocol or FCP.

The backend server 465 also includes a CF interface module 440b to implement intra-cluster communication 470 with N-modules and/or other D-modules. The CF interface modules 440a and 440b can cooperate to provide a single file system image across all D-modules 216 in the cluster. Thus, any network port of an N-module 214 that receives a client request can access any data container within the single file system image located on any D-module 216 of the cluster.

The CF interface modules 440 implement the CF protocol to communicate file system commands among the modules of cluster over the cluster switching fabric 210 (FIG. 2). Such communication can be effected by a D-module exposing a CF application programming interface (API) to which an N-module (or another D-module) issues calls. To that end, a CF interface module 440 can be organized as a CF encoder/decoder. The CF encoder of, e.g., CF interface 440a on N-module 214 can encapsulate a CF message as (i) a local procedure call (LPC) when communicating a file system command to a D-module 216 residing on the same node or (ii) a remote procedure call (RPC) when communicating the command to a D-module residing on a remote node of the cluster. In either case, the CF decoder of CF interface 440b on D-module 216 de-encapsulates the CF message and processes the file system command.

In operation of a node 208, a request from a client 204 is forwarded as a packet over the network 206 and onto the node 208, where it is received at the network adapter 340 (FIG. 3). A network driver of layer 412 processes the packet and, if appropriate, passes it on to a network protocol and file access layer for additional processing prior to forwarding to the storage manager 460. At that point, the storage manager 460 generates operations to load (retrieve) the requested data from disk 212 if it is not resident in memory 320. If the information is not in memory 320, the storage manager 460 indexes into a metadata file to access an appropriate entry and retrieve a logical VBN. The storage manager 460 then passes a message structure including the logical VBN to the RAID system 480; the logical VBN is mapped to a disk identifier and disk block number (DBN) and sent to an appropriate driver (e.g., SCSI) of the disk driver system 490. The disk driver accesses the DBN from the specified disk 212 and loads the requested data block(s) in memory for processing by the node. Upon completion of the request, the node (and operating system) returns a reply to the client 204 over the network 206.

The data request/response “path” through the storage operating system 330 as described above can be implemented in general-purpose programmable hardware executing the storage operating system 330 as software or firmware. Alternatively, it can be implemented at least partially in specially designed hardware. That is, in an alternate embodiment of the invention, some or all of the storage operating system 330 is implemented as logic circuitry embodied within a field programmable gate array (FPGA) or an application specific integrated circuit (ASIC), for example.

The N-module 214 and D-module 216 each can be implemented as processing hardware configured by separately-scheduled processes of storage operating system 330; however, in an alternate embodiment, the modules may be implemented as processing hardware configured by code within a single operating system process. Communication between an N-module 214 and a D-module 216 is thus illustratively effected through the use of message passing between the modules although, in the case of remote communication between an N-module and D-module of different nodes, such message passing occurs over the cluster switching fabric 210. A known message-passing mechanism provided by the storage operating system to transfer information between modules (processes) is the Inter Process Communication (IPC) mechanism. The protocol used with the IPC mechanism is illustratively a generic file and/or block-based “agnostic” CF protocol that comprises a collection of methods/functions constituting a CF API.

### Overview of Content Repository

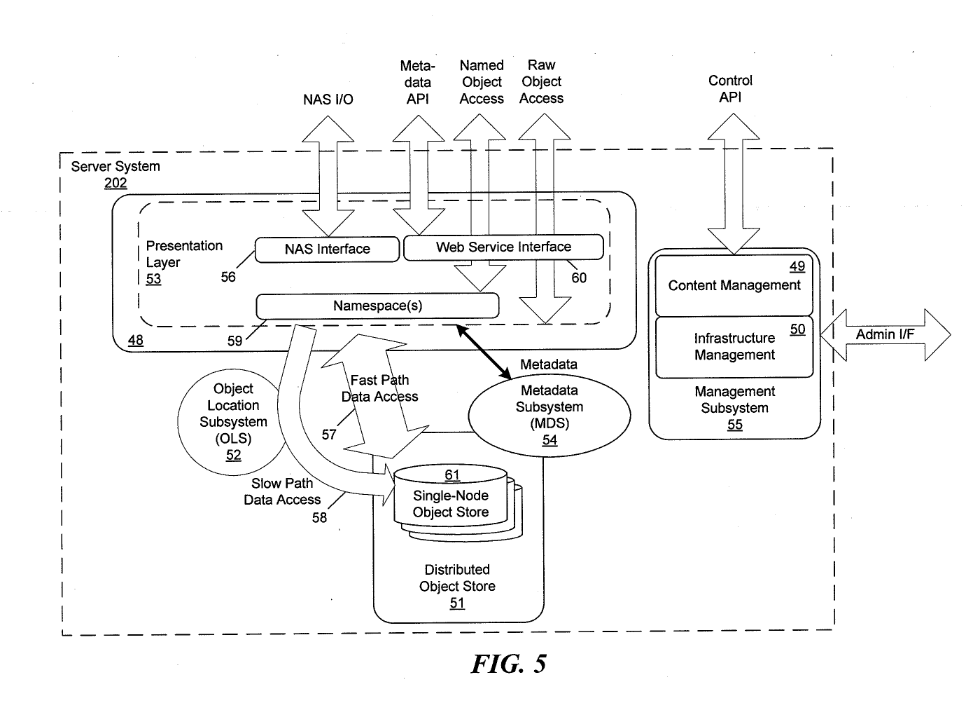

The techniques introduced here generally relate to a content repository implemented in a network storage server system 202 such as described above. FIG. 5 illustrates the overall architecture of the content repository according to one embodiment. The major components of the content repository include a distributed object store 51, and object location subsystem (OLS) 52, a presentation layer 53, a metadata subsystem (MDS) 54 and a management subsystem 55. Normally there will be a single instance of each of these components in the overall content repository, and each of these components can be implemented in any one server node 208 or distributed across two or more server nodes 208. The functional elements of each of these units (i.e., the OLS 52, presentation layer 53, MDS 54 and management subsystem 55) can be implemented by specially designed circuitry, or by programmable circuitry programmed with software and/or firmware, or a combination thereof. The data storage elements of these units can be implemented using any known or convenient form or forms of data storage device.

The distributed object store 51 provides the actual data storage for all data objects in the server system 202 and includes multiple distinct single-node object stores 61. A “single-node” object store is an object store that is implemented entirely within one node. Each single-node object store 61 is a logical (non-physical) container of data, such as a volume or a logical unit (LUN). Some or all of the single-node object stores 61 that make up the distributed object store 51 can be implemented in separate server nodes 208. Alternatively, all of the single-node object stores 61 that make up the distributed object store 51 can be implemented in the same server node. Any given server node 208 can access multiple single-node object stores 61 and can include multiple single-node object stores 61.

The distributed object store provides location-independent addressing of data objects (i.e., data objects can be moved among single-node object stores 61 without changing the data objects' addressing), with the ability to span the object address space across other similar systems spread over geographic distances. Note that the distributed object store 51 has no namespace; the namespace for the server system 202 is provided by the presentation layer 53.

The presentation layer 53 provides access to the distributed object store 51. It is generated by at least one presentation module 48 (i.e., it may be generated collectively by multiple presentation modules 48, one in each multiple server nodes 208). A presentation module 48 can be in the form of specially designed circuitry, or programmable circuitry programmed with software and/or firmware, or a combination thereof.

The presentation layer 53 essentially functions as a router, by receiving client requests, translating them into an internal protocol and sending them to the appropriate D-module 216. The presentation layer 53 provides two or more independent interfaces for accessing stored data, e.g., a conventional NAS interface 56 and a Web Service interface 60. The NAS interface 56 allows access to the object store 51 via one or more conventional NAS protocols, such as NFS and/or CIFS. Thus, the NAS interface 56 provides a filesystem-like interface to the content repository.

The Web Service interface 60 allows access to data stored in the object store 51 via either “named object access” or “raw object access” (also called “flat object access”). Named object access uses a namespace (e.g., a filesystem-like directory-tree interface for accessing data objects), as does NAS access; whereas raw object access uses system-generated global object IDs to access data objects, as described further below. The Web Service interface 60 allows access to the object store 51 via Web Service (as defined by the W3C), using for example, a protocol such as Simple Object Access Protocol (SOAP) or a RESTful (REpresentational State Transfer-ful) protocol, over HTTP.

The presentation layer 53 further provides at least one namespace 59 for accessing data via the NAS interface or the Web Service interface. In one embodiment this includes a Portable Operating System Interface (POSIX) namespace. The NAS interface 56 allows access to data stored in the object store 51 via the namespace(s) 59. The Web Service interface 60 allows access to data stored in the object store 51 via either the namespace(s) 59 (by using named object access) or without using the namespace(s) 59 (by using “raw object access”). Thus, the Web Service interface 60 allows either named object access or raw object access; and while named object access is accomplished using a namespace 59, raw object access is not. Access by the presentation layer 53 to the object store 51 is via either a “fast path” 57 or a “slow path” 58, as discussed further below.

The function of the OLS 52 is to store and provide valid location IDs (and other information, such as policy IDs) of data objects, based on their global object IDs (these parameters are discussed further below). This is done, for example, when a client 204 requests access to a data object by using only the global object ID instead of a complete object handle including the location ID, or when the location ID within an object handle is no longer valid (e.g., because the target data object has been moved). Note that the system 202 thereby provides two distinct paths for accessing stored data, namely, a “fast path” 57 and a “slow path” 58. The fast path 57 provides data access when a valid location ID is provided by a client 204 (e.g., within an object handle). The slow path 58 makes use of the OLS and is used in all other instances of data access. The fast path 57 is so named because a target data object can be located directly from its (valid) location ID, whereas the slow path 58 is so named because it requires a number of additional steps (relative to the fast path) to determine the location of the target data object.

The MDS 54 is a subsystem for search and retrieval of stored data objects, based on metadata. It is accessed by users through the presentation layer 53. The MDS 54 stores data object metadata, which can include metadata specified by users, inferred metadata and/or system-defined metadata. The MDS 54 also allows data objects to be identified and retrieved by searching on any of that metadata. The metadata may be distributed across nodes in the system. In one embodiment where this is the case, the metadata for any particular data object are stored in the same node as the object itself.

As an example of user-specified metadata, users of the system can create and associate various types of tags (e.g., key/value pairs) with data objects, based on which such objects can be searched and located. For example, a user can define a tag called “location” for digital photos, where the value of the tag (e.g., a character string) indicates where the photo was taken. Or, digital music files can be assigned a tag called “mood”, the value of which indicates the mood evoked by the music. On the other hand, the system can also generate or infer metadata based on the data objects themselves and/or accesses to them.

There are two types of inferred metadata: 1) latent and 2) system-generated. Latent inferred metadata is metadata in a data object which can be extracted automatically from the object and can be tagged on the object (examples include Genre, Album in an MP3 object, or Author, DocState in a Word document). System-generated inferred metadata is metadata generated by the server system 202 and includes working set information (e.g., access order information used for object prefetching), and object relationship information; these metadata are generated by the system to enable better “searching” via metadata queries (e.g., the system can track how many times an object has been accessed in the last week, month, year, and thus, allow a user to run a query, such as “Show me all of the JPEG images I have looked at in the last month”). System-defined metadata includes, for example, typical file attributes such as size, creation time, last modification time, last access time, owner, etc.

The MDS 54 includes logic to allow users to associate a tag-value pair with an object and logic that provides two data object retrieval mechanisms. The first retrieval mechanism involves querying the metadata store for objects matching a user-specified search criterion or criteria, and the second involves accessing the value of a tag that was earlier associated with a specific object. The first retrieval mechanism, called a query, can potentially return multiple object handles, while the second retrieval mechanism, called a lookup, deals with a specific object handle of interest.

The management subsystem 55 includes a content management component 49 and an infrastructure management component 50. The infrastructure management component 50 includes logic to allow an administrative user to manage the storage infrastructure (e.g., configuration of nodes, disks, volumes, LUNs, etc.). The content management component 49 is a policy based data management subsystem for managing the lifecycle of data objects (and optionally the metadata) stored in the content repository, based on user-specified policies or policies derived from user-defined SLOs. It can execute actions to enforce defined policies in response to system-defined trigger events and/or user-defined trigger events (e.g., attempted creation, deletion, access or migration of an object). Trigger events do not have to be based on user actions.

The specified policies may relate to, for example, system performance, data protection and data security. Performance related policies may relate to, for example, which logical container a given data object should be placed in, migrated from or to, when the data object should be migrated or deleted, etc. Data protection policies may relate to, for example, data backup and/or data deletion. Data security policies may relate to, for example, when and how data should be encrypted, who has access to particular data, etc. The specified policies can also include polices for power management, storage efficiency, data retention, and deletion criteria. The policies can be specified in any known, convenient or desirable format and method. A “policy” in this context is not necessarily an explicit specification by a user of where to store what data, when to move data, etc. Rather, a “policy” can be a set of specific rules regarding where to store what, when to migrate data, etc., derived by the system from the end user's SLOs, i.e., a more general specification of the end user's expected performance, data protection, security, etc. For example, an administrative user might simply specify a range of performance that can be tolerated with respect to a particular parameter, and in response the management subsystem 55 would identify the appropriate data objects that need to be migrated, where they should get migrated to, and how quickly they need to be migrated.

The content management component 49 uses the metadata tracked by the MDS 54 to determine which objects to act upon (e.g., move, delete, replicate, encrypt, compress). Such metadata may include user-specified metadata and/or system-generated metadata. The content management component 49 includes logic to allow users to define policies and logic to execute/apply those policies.

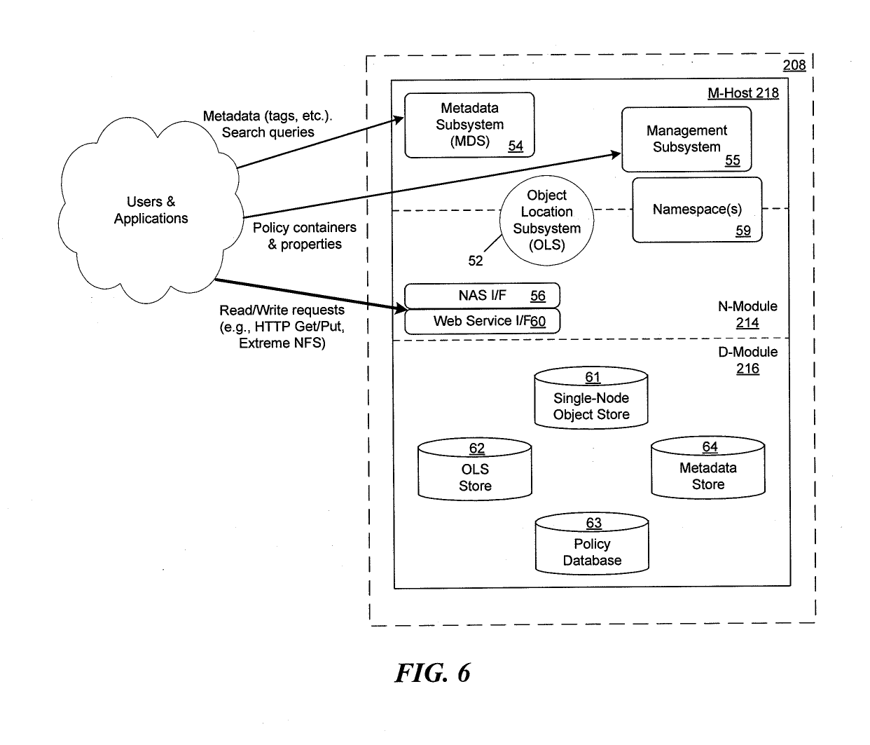

FIG. 6 illustrates an example of how the content repository can be implemented relative to the clustered architecture in FIGS. 2 through 4. Although FIG. 6 illustrates the system relative to a single server node 208, it will be recognized that the configuration shown on the right side of FIG. 6 actually can be implemented by two or more (or all) of the server nodes 208 in a cluster.

In one embodiment, the distributed object store 51 is implemented by providing at least one single-node object store 61 in each of at least two D-modules 216 in the system (any given D-module 216 can include zero or more single node object stores 61). Also implemented in each of at least two D-modules 216 in the system are: an OLS store 62 that contains mapping data structures used by the OLS 52 including valid location IDs and policy IDs; a policy store 63 (e.g., a database) that contains user-specified policies relating to data objects (note that at least some policies or policy information may also be cached in the N-module 214 to improve performance); and a metadata store 64 that contains metadata used by the MDS 54, including user-specified object tags. In practice, the metadata store 64 may be combined with, or implemented as a part of, the single node object store 61.

The presentation layer 53 is implemented at least partially within each N-module 214. In one embodiment, the OLS 52 is implemented partially by the N-module 214 and partially by the corresponding M-host 218, as illustrated in FIG. 6. More specifically, in one embodiment the functions of the OLS 52 are implemented by a special daemon in the M-host 218 and by the presentation layer 53 in the N-module 214.

In one embodiment, the MDS 54 and management subsystem 55 are both implemented at least partially within each M-host 218. Nonetheless, in some embodiments, any of these subsystems may also be implemented at least partially within other modules. For example, at least a portion of the content management component 49 of the management subsystem 55 can be implemented within one or more N-modules 214 to allow, for example, caching of policies in such N-modules and/or execution/application of policies by such N-module(s). In that case, the processing logic and state information for executing/applying policies may be contained in one or more N-modules 214, while processing logic and state information for managing policies is stored in one or more M-hosts 218. As another example, at least a portion of the MDS 54 may be implemented within one or more D-modules 216, to allow it to access more efficiently system generated metadata generated within those modules.

Administrative users can specify policies for use by the management subsystem 55, via a user interface provided by the M-host 218 to access the management subsystem 55. Further, via a user interface provided by the M-host 218 to access the MDS 54, end users can assign metadata tags to data objects, where such tags can be in the form of key/value pairs. Such tags and other metadata can then be searched by the MDS 54 in response to user-specified queries, to locate or allow specified actions to be performed on data objects that meet user-specified criteria. Search queries received by the MDS 54 are applied by the MDS 54 to the single node object store 61 in the appropriate D-module(s) 216.

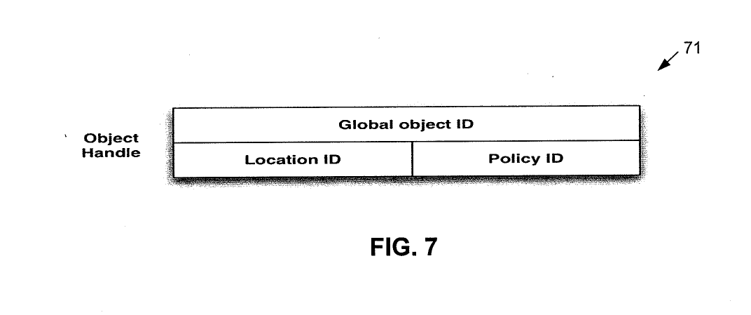

As noted above, the distributed object store enables both path-based access to data objects as well as direct access to data objects. For purposes of direct access, the distributed object store uses a multilevel object handle, as illustrated in FIG. 7. When a client 204 creates a data object, it receives an object handle 71 as the response to creating the object. This is similar to a file handle that is returned when a file is created in a traditional storage system. The first level of the object handle is a system-generated globally unique number, called a global object ID, that is permanently attached to the created data object. The second level of the object handle is a “hint” which includes the location ID of the data object and, in the illustrated embodiment, the policy ID of the data object. Clients 204 can store this object handle 71, containing the global object ID location ID and policy ID.

When a client 204 attempts to read or write the data object using the direct access approach, the client includes the object handle of the object in its read or write request to the server system 202. The server system 202 first attempts to use the location ID (within the object handle), which is intended to be a pointer to the exact location within a volume where the data object is stored. In the common case, this operation succeeds and the object is read/written. This sequence is the “fast path” 57 for I/O (see FIG. 5).

If, however, an object is moved from one location to another (for example, from one volume to another), the server system 202 creates a new location ID for the object. In that case, the old location ID becomes stale (invalid). The client may not be notified that the object has been moved or that the location ID is stale and may not receive the new location ID for the object, at least until the client subsequently attempts to access that data object (e.g., by providing an object handle with an invalid location ID). Or, the client may be notified but may not be able or configured to accept or understand the notification.

The current mapping from global object ID to location ID is always stored reliably in the OLS 52. If, during fast path I/O, the server system 202 discovers that the target data object no longer exists at the location pointed to by the provided location ID, this means that the object must have been either deleted or moved. Therefore, at that point the server system 202 will invoke the OLS 52 to determine the new (valid) location ID for the target object. The server system 202 then uses the new location ID to read/write the target object. At the same time, the server system 202 invalidates the old location ID and returns a new object handle to the client that contains the unchanged and unique global object ID, as well as the new location ID. This process enables clients to transparently adapt to objects that move from one location to another (for example in response to a change in policy).

An enhancement of this technique is for a client 204 never to have to be concerned with refreshing the object handle when the location ID changes. In this case, the server system 202 is responsible for mapping the unchanging global object id to location ID. This can be done efficiently by compactly storing the mapping from global object ID to location ID in, for example, cache memory of one or more N-modules 214.

As noted above, the distributed object store enables path-based access to data objects as well, and such path-based access is explained in further detail in the following sections.

### Object Location Transparency Using the Presentation Layer

In a traditional storage system, a file is represented by a path such as “/u/foo/bar/file.doc”. In this example, “u” is a directory under the root directory “/”, “foo” is a directory under “u”, and so on. Therefore, a file is uniquely identified by a single path. However, since file handles and directory handles are tied to location in a traditional storage system, an entire path name is tied to a specific location (e.g., an inode of the file), making it very difficult to move files around without having to rename them.

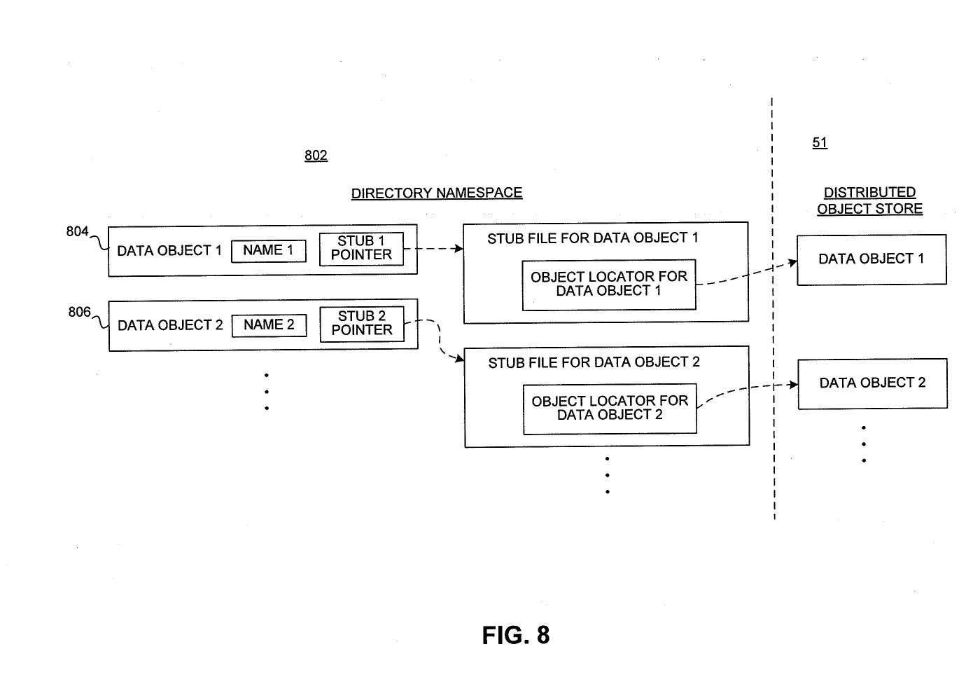

Now refer to FIG. 8, which illustrates a mechanism that allows the server system 202 to break the tight relationship between path names and location. As illustrated in the example of FIG. 8, path names of data objects in the server system 202 are stored in association with a namespace (e.g., a directory namespace 802). The directory namespace 802 maintains a separate directory (e.g., 804, 806) entry for each data object stored in the distributed object store 51. A directory entry, as indicated herein, refers to an entry that describes a name of any type of data object (e.g., directories, files, logical containers of data, etc.). Each directory entry includes a path name (e.g., NAME 1) (i.e., a logical address) of the data object and a pointer (e.g., REDIRECTOR POINTER 1) for mapping the directory entry to the data object.

In a traditional storage system, the pointer (e.g., an inode number) directly maps the path name to an inode associated with the data object. On the other hand, in the illustrated embodiment shown in FIG. 8, the pointer of each data object points to a “redirector file” associated with the data object. A redirector file, as indicated herein, refers to a file that maintains an object locator of the data object. The object locator of the data object could either be the multilevel object handle 71 (FIG. 7) or just the global object ID of the data object. In the illustrated embodiment, the redirector file (e.g., redirector file for data object 1) is also stored within the directory namespace 802. In addition to the object locator data, the redirector file may also contain other data, such as metadata about the location of the redirector file, etc.

As illustrated in FIG. 8, for example, the pointer included in the directory entry 804 of data object 1 points to a redirector file 808 for data object 1 (instead of pointing to, for example, the inode of data object 1). The directory entry 804 does not include any inode references to data object 1. The redirector file for data object 1 includes an object locator (i.e., the object handle or the global object ID) of data object 1. As indicated above, either the object handle or the global object ID of a data object is useful for identifying the specific location (e.g., a physical address) of the data object within the distributed object store 51. Accordingly, the server system 202 can map the directory entry of each data object to the specific location of the data object within the distributed object store 51. By using this mapping in conjunction with the OLS 52 (i.e., by mapping the path name to the global object ID and then mapping the global object ID to the location ID), the server system 202 can mimic a traditional file system hierarchy, while providing the advantage of location independence of directory entries.

By having the directory entry pointer of a data object point to a redirector file (containing the object locator information) instead of pointing to an actual inode of the data object, the server system 202 introduces a layer of indirection between (i.e., provides a logical separation of) directory entries and storage locations of the stored data object. This separation facilitates transparent migration (i.e., a data object can be moved without affecting its name), and moreover, it enables any particular data object to be represented by multiple path names, thereby facilitating navigation. In particular, this allows the implementation of a hierarchical protocol such as NFS on top of an object store, while at the same time allowing access via a flat object address space (wherein clients directly use the global object ID to access objects) and maintaining the ability to do transparent migration.

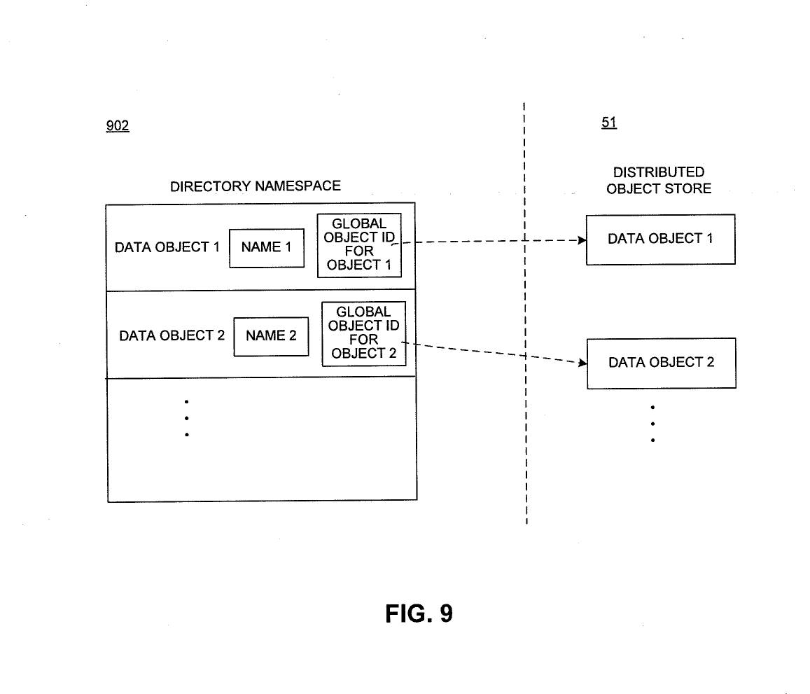

In one embodiment, instead of using a redirector file for maintaining the object locator (i.e., the object handle or the global object ID) of a data object, the server system 202 stores the global object ID of the data object directly within the directory entry of the data object. An example of such an embodiment is depicted in FIG. 9. In the illustrated example, the directory entry for data object 1 includes a path name and the global object ID of data object 1. In a traditional server system, the directory entry would contain a path name and a reference to an inode (e.g., the inode number) of the data object. Instead of storing the inode reference, the server system 202 stores the global object ID of data object 1 in conjunction with the path name within the directory entry of data object 1. As explained above, the server system 202 can use the global object ID of data object 1 to identify the specific location of data object 1 within the distributed object store 51. In this embodiment, the directory entry includes an object locator (i.e., a global object ID) instead of directly pointing to the inode of the data object, and therefore still maintains a layer of indirection between the directory entry and the physical storage location of the data object. As indicated above, the global object ID is permanently attached to the data object and remains unchanged even if the data object is relocated within the distributed object store 51.

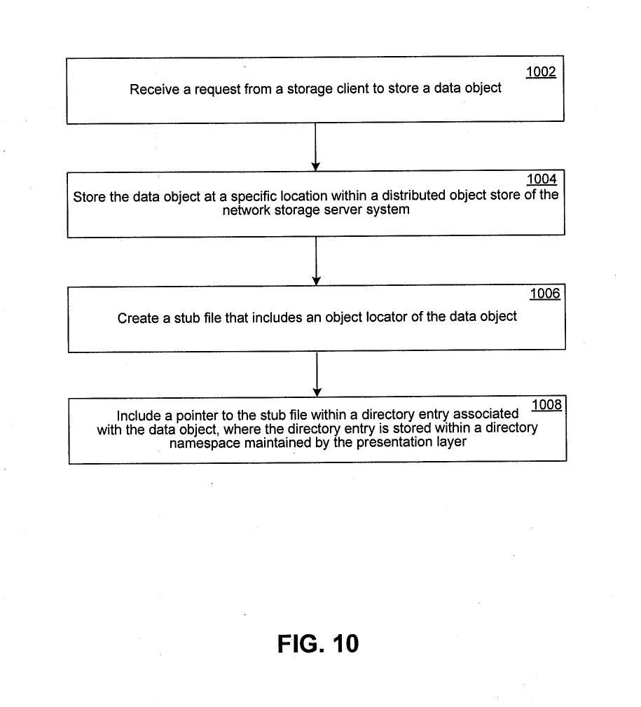

Refer now to FIG. 10, which shows an example of a process by which the server system 202 stores a data object received from a storage client, while keeping the directory entry of the data object transparent from the storage location of the data object. At 1002, the server system 202 receives a request from a storage client 204 to store a data object. The server system 202 receives such a request, for example, when the storage client 204 creates the data object. In response to the request, at 1004, the server system 202 stores the data object at a specific location (i.e., a specific storage location within a specific volume) in the distributed object store 51. In some embodiments, as a result of this operation, the server system 202 obtains the Object ID and the location ID (i.e., the object handle of the newly created object) from the distributed object store.

At 1006, the server system 202 creates a redirector file and includes the object locator (either the object handle or the global object ID) of the data object within the redirector file. As indicated at 1008, the server system 202 stores the redirector file within the object space 59B maintained by the presentation layer 53. Subsequently, the server system 202 establishes a directory entry for the data object within a directory namespace (or a NAS path namespace) maintained by the presentation layer 53. This NAS path namespace is visible to (and can be manipulated by) the client/application. For example, when a client instructs the server system 202 to create an object “bar” in path “Moo,” the server system 202 finds the directory /foo in this namespace and creates the entry for “bar” in there, with the entry pointing to the redirector file for the new object. The directory entry established here includes at least two components: a path name defining the logical path of the data object, and a pointer providing a reference to the redirector file containing the object locator. It is instructive to note that the directory entry is typically not the whole path name, just the name of the object within that pathname, In the above example, the name “bar” would be put in a new directory entry in the directory “foo” which is located under directory “/.”

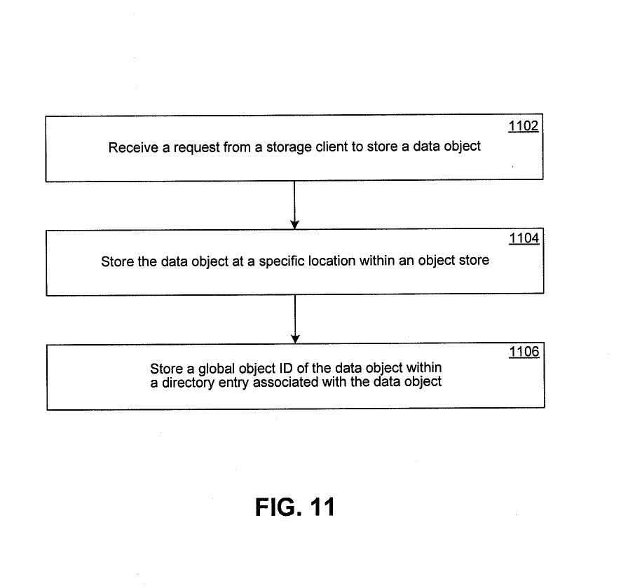

FIG. 11 is another example of a process by which the server system 202 stores a data object received from a storage client 204, while keeping the directory entry of the data object transparent from the storage location of the data object. At 1102, the server system 202 receives a request from a storage client 204 to store a data object. In response to the request, at 1104, the server system 202 stores the data object at a specific location (i.e., a specific storage location within a specific volume) in the distributed object store 51.

At 1106, the server system 202 establishes a directory entry for the data object within a directory namespace (or a NAS path namespace) maintained by the presentation layer 53. The directory entry established here includes at least two components: a path name defining the logical path of the data object, and the global object ID of the data object. Accordingly, instead of creating a separate redirector file to store an object locator (as illustrated in the exemplary process of FIG. 10), the server system 202 directly stores the global object ID within the directory entry of the data object. As explained above, the global object ID is permanently attached to the data object and does not change even if the data object is relocated within the distributed object store 51. Consequently, the directory entry of the data object remains unchanged even if the data object is relocated within the distributed object store 51. Therefore, the specific location of the data object still remains transparent from the directory entry associated with the data object.

When a client attempts to write or read a data object that is stored in the object store 51, the client includes an appropriate object locator (e.g., the object handle of the data object) in its read or write request to the server system 202. In order to be able to include the object locator with its request (if the client does not have the object locator), the client first requests a “lookup” of the data object; i.e., the client requests the server system 202 to transmit an object locator of the data object. In some instances, the object locator is encapsulated within, for example, a file handle returned by the lookup call.

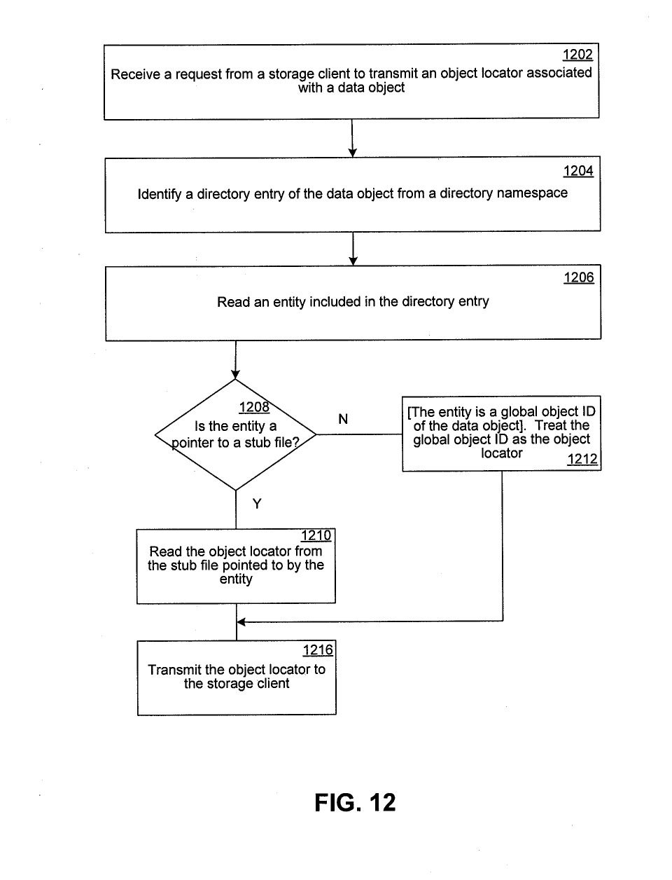

Refer now to FIG. 12, which is a flow diagram showing an example of a process by which the server system 202 responds to such a lookup request made by a storage client. At 1202, the server system 202 receives a request from a storage client 204 to transmit an object locator of a data object. At 1204, the server system 202 identifies a corresponding directory entry of the data object. As indicated above, the directory entry of the data object is stored in a directory namespace (or a NAS path namespace) maintained by the presentation layer 53. At 1206, the server system 202 reads an entity included in the directory entry. The entity could either be a pointer to a redirector file of the data object or could directly be a global object ID of the data object.

At 1208, the server system 202 determines whether the entity is a pointer to a redirector file or the actual global object ID. If the server system determines that the entity is a pointer to a redirector file, the process proceeds to 1210, where the server system 202 reads the redirector file and reads the object locator (either an object handle or a global object ID) from the redirector file. On the other hand, if the server system 202 determines at 1208 that the entity does is not a reference to a redirector file, the server system 202 recognizes that the entity is the global object ID of the data object. Accordingly, the process shifts to 1212, where the server system 202 reads the global object ID as the object locator. In either scenario, subsequent to the server system 202 reading the object locator, the process shifts to 1216, where the object locator is transmitted back to the storage client 204.

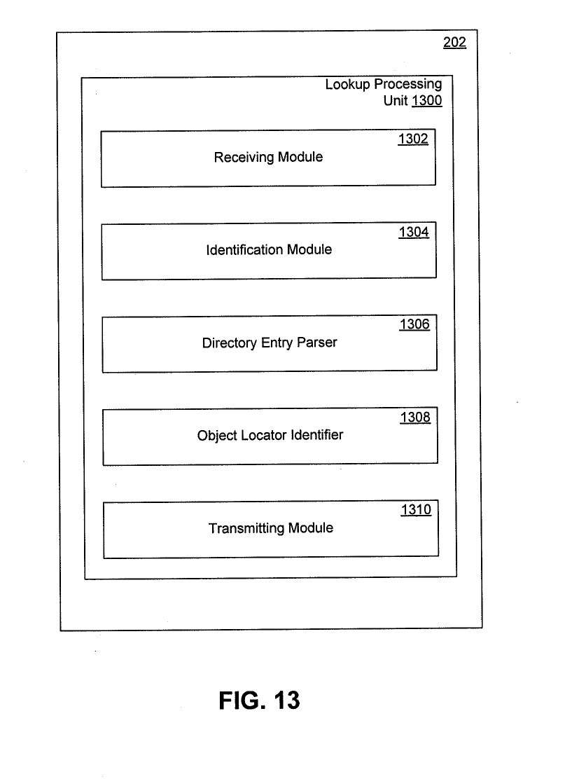

FIG. 13 is an exemplary architecture of the server system 202 configured, for example, to transmit an object locator to a client in response to a request from the client 204. In the illustrated example, the server system 202 includes a lookup processing unit 1300 that performs various functions to respond to the client's request. In some instances, the lookup processing unit 1300 is implemented by using programmable circuitry programmed by software and/or firmware, or by using special-purpose hardwired circuitry, or by using a combination of such embodiments. In some instances, the lookup processing unit 1300 is implemented as a unit in the processor 310 of the server system 202.

In the illustrated example, the lookup processing unit 1300 includes a receiving module 1302, an identification module 130, a directory entry parser 1306, an object locator identifier 1308, and a transmitting module 1310. The receiving module 1302 is configured to receive a request from the client 204 to transmit an object locator associated with a data object (i.e., a lookup request). An identification module 1304 of the lookup processing unit 1300 communicates with the receiving module 1302 to accept the request. The identification module 1304 parses the directory namespace (i.e., a NAS path namespace) to identify a directory entry associated with the data object. The identification module 1304 submits the identified directory entry to a directory entry parser 1306 for further analysis. The directory entry parser 1306 analyzes the directory entry to identify an entity included in the directory entry. An object locator identifier 1308 works in conjunction with the directory entry parser 1306 to read the object locator from the identified entity. If the entity is a pointer to a redirector file, the object locator identifier 1308 reads the redirector file and extracts the object locator (either an object handle or a global object ID of the data object) from the redirector file. On the other hand, if the entity is a global object ID of the data object, the object locator extractor 1308 directly reads the object locator (i.e., the global object ID) from the directory entry. A transmitting module 1310 communicates with the object locator extractor 1308 to receive the extracted object locator and subsequently transmit the object locator to the client 204.

The techniques introduced above can be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware for implementing the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

The term “logic”, as used herein, can include, for example, special-purpose hardwired circuitry, software and/or firmware in conjunction with programmable circuitry, or a combination thereof.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method of operating a network storage server, the method comprising:
storing, in a directory namespace of the network storage server, a directory entry associated with a data object, wherein the data object is stored at a specific location within an object store of the network storage server; and
including, by the network storage server, an entity within the directory entry, wherein the entity is indicative of the specific location of the data object within the object store, and wherein the entity is such that the directory entry remains unchanged even if the data object is relocated within the object store.

2. The method of claim 1, wherein the directory entry does not include a reference to an inode associated with the data object.

3. The method of claim 1, wherein the directory entry remains unchanged even if an inode number associated with the data object changes.

4. The method of claim 1, wherein the directory entry includes:
a path name of the data object, wherein the path name indicates a logical address of the data object; and
the entity.

5. The method of claim 1, wherein the directory namespace is a NAS path namespace of the network storage server.

6. The method of claim 1, wherein the entity is a pointer to a redirector file, the redirector file including an object locator of the data object.

7. The method of claim 1, wherein the entity is a global object ID of the data object.

8. The method of claim 6, wherein the object locator is an object handle associated with the data object, wherein:
a first level of the object handle is a global object identifier of the data object that is permanently attached to the data object, wherein the global object identifier remains unchanged even if the specific location of the data object changes within the object store; and
a second level of the object handle includes a location identifier of the data object, the location identifier providing an exact location of the data object in a storage volume of the object store, wherein the location identifier changes if the specific location of the data object changes within the object store.

9. The method of claim 6, wherein the object locator is a global object identifier associated with the data object, wherein the global object identifier remains unchanged even if the specific location of the data object changes within the object store.

10. A method of operating a network storage server, the method comprising:
receiving, at the network storage server, a request to store a data object;
storing, at the network storage server, the data object at a specific location within an object store;
creating, at the network storage server, a redirector file that includes an object locator of the data object, the object locator including information associated with the specific location of the data object within the object store;
storing the redirector file within the network storage server; and
including, at the network storage server, a pointer to the redirector file within a directory entry associated with the data object, the directory entry included within a directory namespace of the network storage server.

11. The method of claim 10, wherein the directory entry does not include a reference to an inode associated with the data object.

12. The method of claim 10, wherein the directory entry remains unchanged even if an inode number of the data object changes in value.

13. The method of claim 10, wherein the directory entry associated with the data object includes:
a path name of the data object, wherein the path name indicates a logical address of the data object; and
the pointer.

14. The method of claim 10, wherein the directory entry associated with the data object remains unchanged even if the specific location of the data object changes within the object store.

15. The method of claim 10, wherein information included in the redirector file changes if the specific location of the data object changes within the object store.

16. The method of claim 10, wherein the directory namespace is a NAS path namespace.

17. The method of claim 10, wherein the object locator is an object handle associated with the data object, wherein:
a first level of the object handle is a global object identifier of the data object that is permanently attached to the data object, wherein the global object identifier remains unchanged even if the specific location of the data object changes within the object store; and
a second level of the object handle includes a location identifier of the data object, the location identifier providing an exact location of the data object in a storage volume of the object store, wherein the location identifier changes if the specific location of the data object changes within the object store.

18. The method of claim 10, wherein the object locator is a global object ID of the data object, wherein the global object ID remains unchanged even if the specific location of the data object changes within the object store.

19. A method of operating a network storage server, the method comprising:
receiving, at the network storage server, a request to store a data object;
storing the data object at a specific location within an object store of the network storage server; and
storing, at the network storage server, a global object ID of the data object within a directory entry associated with the data object, wherein:
the global object ID is permanently attached to the data object and includes information indicative of a physical location of the data object;
the global object ID remains unchanged even if the data object is relocated within the object store; and
the directory entry is stored in a NAS path namespace maintained by the network storage server.

20. The method of claim 19, wherein the directory entry does not include a reference to an inode associated with the data object.

21. The method of claim 19, wherein the NAS path namespace is maintained by a presentation layer of the network storage server.

22. The method of claim 19, wherein the directory entry associated with the data object includes:
a path name of the data object, wherein the path name indicates a logical address of the data object; and
the global object ID.

23. The method of claim 19, wherein the directory entry associated with the data object remains unchanged even if the data object is relocated within the object store.

24. A network storage server system comprising:
a processor;
a network interface through which to communicate with a plurality of storage clients over a network;
a storage interface through which to communicate with a nonvolatile mass storage subsystem; and
a memory storing code which, when executed by the processor, causes the network storage server system to perform a plurality of operations, including:
receiving a request from a storage client to store a data object;
storing the data object at a specific location within an object store of the network storage server system;
creating a redirector file that includes an object locator of the data object, the object locator including information associated with the specific location of the data object within the object store;
storing the redirector file within the network storage system; and
including a pointer to the redirector file within a directory entry associated with the data object, the directory entry included within a directory namespace of the network storage server system.

25. The system of claim 24, wherein the directory entry does not include a reference to an inode associated with the data object.

26. The system of claim 25, wherein the directory entry associated with the data object includes:
a path name of the data object, wherein the path name indicates a logical address of the data object; and
the pointer.

27. The system of claim 24, wherein the directory entry associated with the data object remains unchanged even if the specific location of the data object changes within the object store.

28. The system of claim 25, wherein information included in the redirector file changes if the specific location of the data object changes within the object store.

29. The system of claim 24, wherein the directory namespace is a NAS path namespace.

30. The system of claim 24, wherein the object locator is one of:
an object handle associated with the data object; or
a global object identifier associated with the data object.

31. A network storage server system comprising:
a processor;
a network interface through which to communicate with a plurality of storage clients over a network;
a storage interface through which to communicate with a nonvolatile mass storage subsystem; and
a memory storing code which, when executed by the processor, causes the network storage server system to perform a plurality of operations, including:
receiving a request to store a data object;
storing the data object within an object store of the network storage server system; and
storing a global object ID of the data object within a directory entry associated with the data object, wherein:
the global object ID is permanently attached to the data object and includes information indicative of a physical location of the data object;
the global object ID remains unchanged even if the data object is relocated within the object store; and
the directory entry is stored in a NAS path namespace maintained by the network storage server system.

32. The system of claim 31, wherein the directory entry does not include a reference to an inode associated with the data object.

33. A method of operating a network storage server, the method comprising:
receiving, at the network storage server, a request to transmit an object locator associated with a data object, wherein the data object is stored in a specific location within an object store, and wherein the object locator includes information associated with the specific location of the data object;
identifying, by the network storage server, a directory entry associated with the data object;
reading, by the network storage server, an entity included in the directory entry;
identifying, by the network storage server, the object locator from the entity, wherein:
if the entity is a global object ID of the data object, the object locator is the global object ID included in the directory entry; or
if the entity is a pointer to a redirector file associated with the data object, the object locator is an object handle or a global object ID included within the redirector file; and
transmitting, by the network storage server, the identified object locator in response to the request.

34. The method of claim 33, wherein the request is received from a storage client connected to the network storage server.

35. The method of claim 34, wherein the storage client utilizes the identified object locator to read or write to the data object.

36. The method of claim 33, wherein the directory entry does not include a reference to an inode associated with the data object.

37. A network storage system comprising:
a receiving module configured to receive a request from a client to transmit an object locator associated with a data object, wherein the data object is stored in a specific location within an object store, and wherein the object locator includes information associated with the specific location of the data object;
an identification module configured to identify a directory entry associated with the data object;
a directory entry parser configured to read an entity included in the directory entry;
an object locator identifier configured to identify the object locator from the entity, wherein:
if the entity is a global object ID of the data object, the object locator is the global object ID included in the directory entry; or
if the entity is a pointer to a redirector file associated with the data object, the object locator is an object handle or a global object ID included within the redirector file; and
a transmitting module configured to transmit the identified object locator to the client.
